(19) United States
(12) Patent Application Publication
(10) Pub. No.: US 2025/0258058 A1
(43) Pub. Date: Aug. 14, 2025

(54) METHOD AND SYSTEM FOR STRUCTURAL DIAGNOSIS OF CONCRETE RAILWAY SLEEPERS

(71) Applicant: SOL SOLUTION, RIOM (FR)

(72) Inventor: Sébastien BARBIER, RIOM (FR)

(21) Appl. No.: 19/045,133

(22) Filed: Feb. 4, 2025

(30) Foreign Application Priority Data
Feb. 9, 2024 (FR) 2401275

(51) Int. Cl. G01M 5/00

(52) U.S. Cl. CPC G01M 5/0066; G01M 5/0025

(57) ABSTRACT

The structural diagnosis method comprises four steps, namely an application step, wherein a mechanical stress is applied by impact to a concrete railroad tie (2, 3) to be diagnosed, a detection step, wherein a vibration generated by the mechanical stress and propagating in the diagnosed tie is detected on the surface of the diagnosed tie and transformed into a time-dependent vibratory signal, a processing step, wherein the time-dependent vibratory signal is electronically processed to obtain a frequency spectrum therefrom, and an analysis step, wherein the diagnosis reference is compared to a structural damage.

The present invention relates to a method and system for structural diagnosis of concrete railroad ties.

Railroad ties are parts laid across a railroad track, on which the rails are fastened so as to maintain the gage and the inclination of the rails, and which transmit loads moving on the rails to a ballast on which the railroad ties rest. We are more specifically interested herein in so-called “concrete” ties, the ties being either monoblock, then consisting of a single concrete piece extending over the entire longitudinal dimension of the ties, or bi-block, then consisting of two concrete terminal support blocks, connected to each other by a central metal spacer.

Concrete railroad ties have, a priori, a long service life, which can reach several decades. However, in certain circumstances, the railroad ties exhibit structural damage that is more marked than the expected normal wear and tear thereof. The causes or reasons for such situation are diverse and induce structural consequences that are equally varied: without thereof being exhaustive, we can cite the erosion of contact between the underside of the tie and the ballast, spalling and similar damage related to transport and/or maintenance operations, overstress cracks in service, chemical cracks following alkali-aggregate reactions, thermal shrinkage cracks during the manufacture of the ties, etc. In any case, it is difficult to assess in a non-destructive way, the structural damage of the ties, typically by simple visual observation in situ, i.e. directly on the railroad: indeed, the observation conditions are often average, and a large part of the ties are hidden by the ballast or is under the rails, unless the tie is removed from the railroad and, where appropriate, is subsequently examined in a testing laboratory, which is particularly tedious. Moreover, even if cracks are observable on the surface of the ties, it is almost impossible to reliably deduce whether the corresponding structural damage is critical for the ties, to the point of requiring urgent replacement. More generally, there is a real need to be able to structurally diagnose concrete railroad ties in situ, in order to effectively manage the maintenance thereof in the broad sense.

Documents WO 2018/134506 A1 et US 2017/219471 A1 mention a method for structural diagnosis of concrete railroad ties, based on a mechanical stress on the railroad tie and the detection of the vibrations generated by the stress. Document US 2017/219471 A1 discloses an analysis of the travel time of the vibrations through the tie. Document WO 2018/134506 A1 discloses an analysis of the natural frequency of the frequency spectrum resulting from the detected vibratory signal, with respect to reference values of damage to the tie.

However, there is always a need for improvement, in particular in the reliability of the analysis, the simplicity of acquisition of the diagnosis by the operator, and the ease of implementation of the invention.

The goal of the present invention is to propose a method and a system which make it possible to structurally diagnose concrete railroad ties in a reliable, rapid and simple manner, where appropriate directly on the railroad track.

To this end, the subject matter of the invention is a method of structural diagnosis of concrete railroad ties, comprising:
an application step, wherein a mechanical stress is applied by impact to a concrete railroad tie to be diagnosed,
a detection step, wherein a vibration generated by the mechanical stress and propagating through the diagnosed tie is detected on the surface of the diagnosed tie and is transformed into a time-dependent vibratory signal,
a processing step, wherein the time-dependent vibratory signal is processed electronically so as to obtain a frequency spectrum, and
an analysis step, wherein the frequency spectrum is compared with a reference in order to derive therefrom a structural damage characterization of the diagnosed tie,
wherein, in the analysis step, (i) the frequency spectrum is compared, by computer means, with a reference spectrum forming said reference, by computing a distance score which is representative of a mathematical distance between the frequency spectrum and the reference spectrum, and (ii) the structural damage characterization is determined from the computed distance score.

A further subject matter of the invention is a structural diagnosis system for concrete railroad ties, comprising:
at least one impactor suitable for applying mechanical stress by impact to a concrete railroad tie to be diagnosed,
at least one sensor suitable for both detecting, on the surface of the diagnosed tie, a vibration generated by the mechanical stress and propagating in the diagnosed tie, and for transforming the vibration into a time-dependent vibratory signal,
an electronic processing unit, suitable for processing the time-dependent vibratory signal so as to obtain a frequency spectrum therefrom, and
means of analysis, suitable for comparing the frequency spectrum with a reference in order to deduce therefrom a structural damage characterization of the diagnosed tie,
wherein the means of analysis are configured to carry out an analysis step, wherein (i) the frequency spectrum is compared, by computer means, with a reference spectrum forming a reference, by computing a distance score that is representative of a mathematical distance between the frequency spectrum and the reference spectrum, and (ii) the structural damage characterization is determined from the computed distance score.

One of the ideas underlying the invention is to seek to give a structural damage characterization of a concrete railroad tie from a simple non-destructive impact, applied to the tie to be diagnosed, in particular in situ, i.e. directly on the railroad track where the tie is used, which is particularly simple and practical to implement. The structural damage characterization is dimensionless, in the sense that same does not quantify a geometric dimension or a dimensional parameter of the diagnosed tie, but the structural damage characterization associates the diagnosed tie with one structural state amongst a plurality of states. Thereby, the structural damage characterization advantageously provides information, within a controlled margin of error, (i) on the presence of at least one structural defect falling within one or a plurality of given types of defect and/or (ii) on a different structural wear, and thus potentially greater, than a nominal structural wear. To this end, the invention provides that the vibration generated in the tie by the aforementioned impact is detected at the surface of the tie and transformed into a time-dependent vibratory signal, in practice by means of one or a plurality of ad hoc sensors. The signal is then processed, more particularly by an ad hoc electronic processing unit, to change from the time domain to a frequency domain, in the form of a frequency spectrum, advantageously provided in situ. The analysis of the frequency spectrum then serves to determine the structural damage characterization of the diagnosed tie, by comparison with a predetermined reference which is e.g. obtained from a reference tie, typically new or considered healthy, or from the prior statistical processing of a homogeneous population of ties. Such analysis of the frequency spectrum can either be performed partially by a human operator, in particular to whom the frequency spectrum and the aforementioned reference are displayed on a screen, advantageously in situ, or performed entirely by ad hoc computer means, where appropriate partially distant, as explained in detail thereafter. In all cases, the corresponding means of analysis are particularly practical and serve to control the reliability of the diagnosis provided, i.e. the structural damage characterization which is deduced by or due to such means of analysis.

According to advantageous optional features of the method and/or the system of structural diagnosis according to the invention, taken individually or according to all technically possible combinations:
the application step, the detection step and the processing step, and at least a part of the analysis step, are carried out on railroad tracks.
in the application step, the mechanical stress is applied to the tie to be diagnosed by an impact having an energy of less than 3 joules, preferably less than 1 joule.
in the processing step, the time-dependent vibratory signal is processed so as to extract a significant part therefrom, before applying to the significant part a bandpass filter and then a mathematical transformation on a frequency domain to get the frequency spectrum.

The bandpass filter has a low cut-off frequency substantially equal to 3,000 Hz, preferably 3,500 Hz, and a high cut-off frequency substantially equal to 20,000 HZ, preferably 15,500 Hz.
the impactor(s), the sensor(s) and the electronic processing unit, and at least part of the means of analysis, form a portable equipment assembly, usable by a human operator on the railroad track.

The invention will be better understood upon reading the following description, given only as an example and making reference to the drawings, wherein:

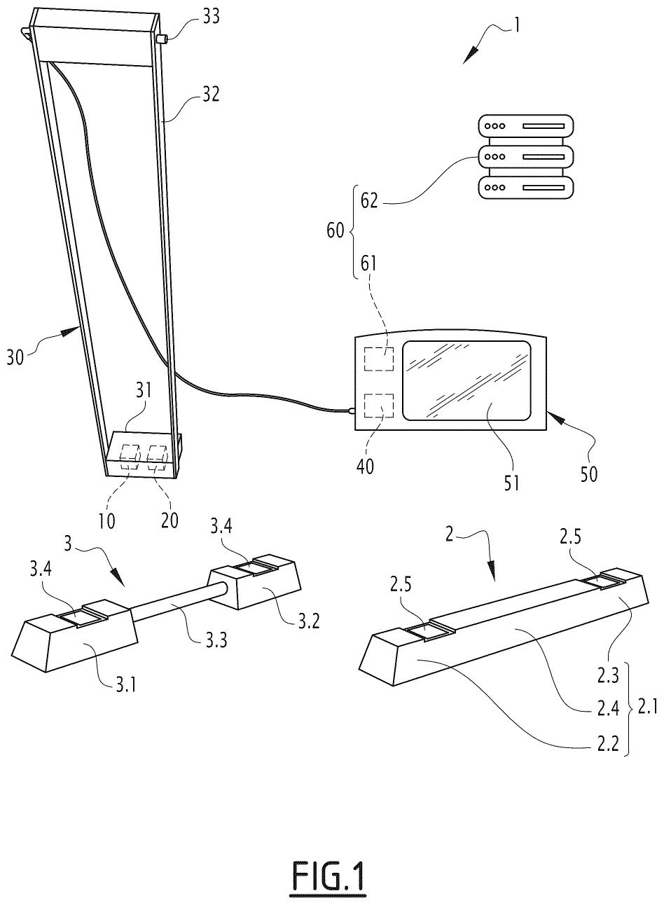

FIG. 1 is a schematic perspective view of two concrete railroad ties and of a structural diagnosis system for such ties;

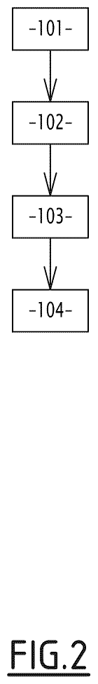

FIG. 2 is a flowchart of a method of structural diagnosis, implemented by the structural diagnosis system shown in FIG. 1;

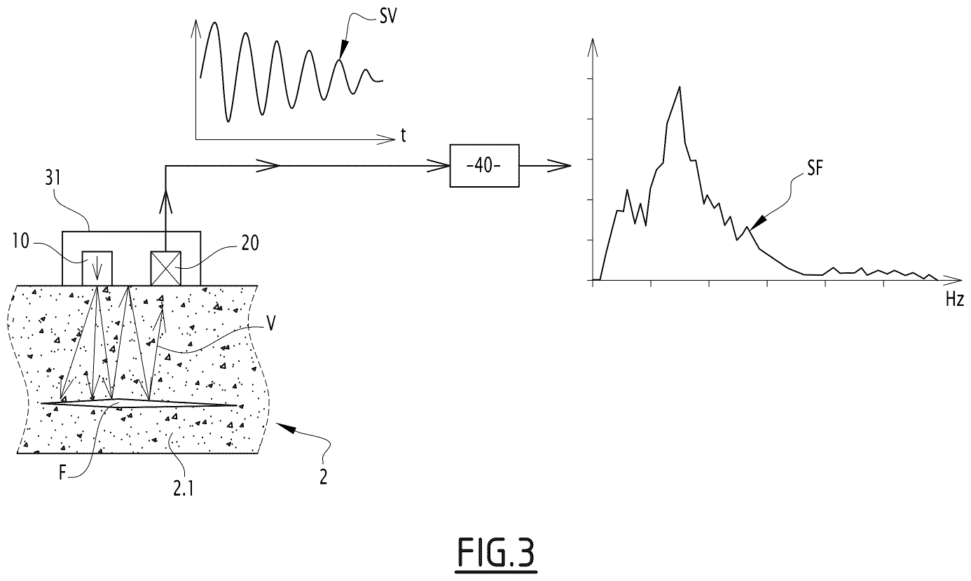

FIG. 3 is a schematic section of a part of the structural diagnosis system of FIG. 1, used on a tie, the section being schematically associated with signals produced by the structural diagnosis system;

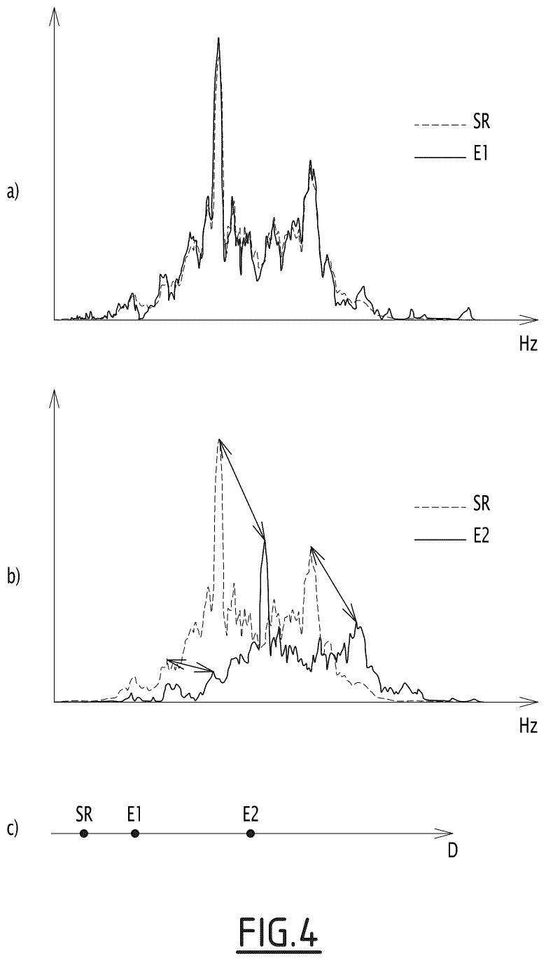

FIG. 4 includes inserts a) and b) corresponding to frequency spectrum patterns implemented correspondingly in the structural diagnosis method, and an insert c) corresponding to a distance score pattern, also implemented in the structural diagnosis method; and

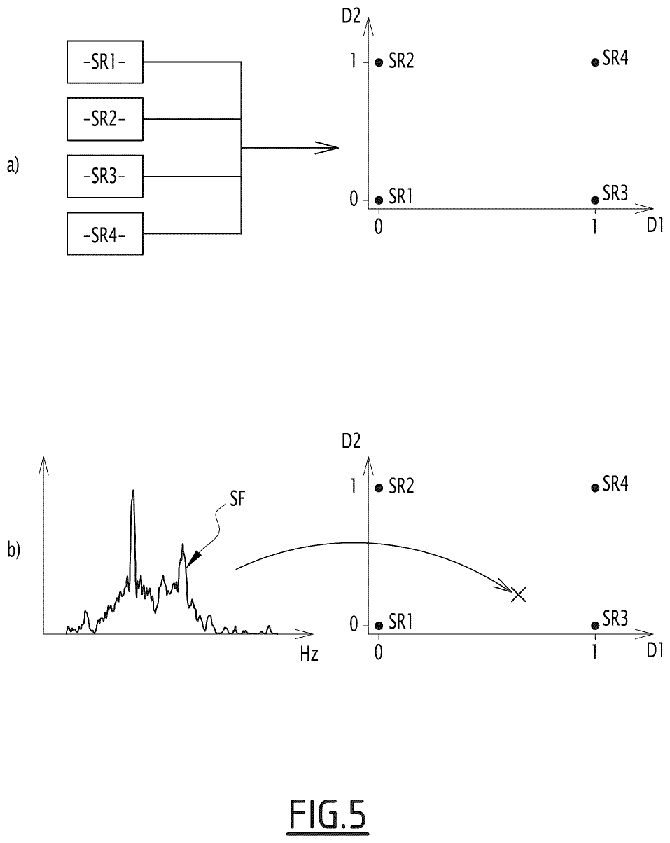

FIG. 5 includes two inserts a) and b) which correspond to diagrams, respectively, including a representation space, implemented in the structural diagnosis method.

FIG. 1 shows a structural diagnosis system 1 for non-destructively inspecting the concrete structure of concrete railroad ties, such as ties 2 and 3 shown in FIG. 1 as examples.

The tie 2 is a so-called monoblock tie and comprises a concrete body 2.1 extending continuously from one to the other of two ends of the tie 2, opposite one another along a longitudinal direction of the tie 2. The concrete body 2.1 includes two end portions 2.2 and 2.3 which are opposite each other along the longitudinal direction of the tie 2, and an intermediate portion 2.4 which connects the end portions 2.2 and 2.3 to each other and which is possibly thinned with respect to the end portions 2.2 and 2.3. The tie 2 is provided, on each of the terminal parts 2.2 and 2.3 thereof, with fitting-outs 2.5 intended for the fastening of a railroad rail, not shown in the figures. The tie 2 optionally includes a reinforcement of metal wires embedded in the concrete body 2.1.

The tie 3 is a so-called bi-block tie and comprises two concrete support blocks 3.1 and 3.2 which form two end parts of the tie 3 opposite each other along a longitudinal direction of the tie 3 and which are connected to each other by a metal spacer 3.3. In a similar manner to the tie 2, the tie 3 is provided, on each of the concrete support blocks 3.1 and 3.2, with fitting-outs 3.4 intended for the fastening of a railroad rail.

The specificities of the tie 2 and of the tie 3 are not limiting, henceforth the structure thereof is mainly, but not necessarily exclusively, made of concrete, like the concrete body 2.1 for the tie 2 and the concrete support blocks 3.1 and 3.2 for the tie 3. Thereby, the concrete of the ties 2 and 3 is e.g. reinforced, pre-stressed or post-stressed. 15

In any case, in the usual manner in the field and without thereof being shown in FIG. 1, the tie 2 and the tie 3 are used equally well in a railroad track which includes both a support, typically a ballast, on which rests a group of ties, such as the ties 2 and 3, distributed regularly along a longitudinal direction of the railroad track, and rails, which extend lengthwise along the longitudinal direction of the railroad track and which are 20 fastened to the ties, at the fitting-outs intended for the latter, such as the fitting-outs 2.5 for the tie 2 and the fitting-outs 3.4 for the tie 3.

Whatever the specificities of the ties 2 and 3, the concrete structure thereof necessarily changes over time, undergoing structural damage. The structural damage results from the wear, which can be described as normal, of the ties 2 and 3, linked in particular to the stresses that the ties transmit between the ballast and the railroad rolling stock on the rails of the railroad track. As mentioned in the introductory part of the present document, under certain conditions of use and/or due to certain manufacturing conditions of the ties 2 and 3, the structural damage to the ties is likely to be greater than normal wear and tear. More particularly, cracks or other structural defects are likely to appear and substantially and rapidly degrade the structural damage. Since such structural defects appear in the concrete structure of the ties 2 and 3, the service life of these ties may be less than the service life of the same ties, but which do not have such structural defects.

In order to characterize the effective structural damage of concrete railroad ties, such as ties 2 and 3, when the ties are used in a railroad, it is proposed to implement a structural diagnosis method, which will be described in detail hereinbelow. Hereinafter, the structural diagnosis method is applied e.g. to the tie 2 but it will be understood that the structural diagnosis method is equally applicable to the tie 3. An embodiment of the structural diagnosis method is illustrated schematically in FIG. 2 and is advantageously implemented by the structural diagnosis system 1, appropriately controlled by a human operator.

As illustrated in FIG. 2, the structural diagnosis method includes four successive main steps, namely an application step 101, a detection step 102, a processing step 103 and an analysis step 104. Before successively describing each of the four steps in detail, it will be noted that the application step 101, the detection step 102 and the processing step 103, as well as at least part of the analysis step 104, are advantageously implemented in situ, i.e. directly on the railroad track, more particularly when the concrete ties of the latter are left unaltered, in other words maintained in an operational situation within the railroad track.

In the application step 101, a mechanical stress is applied by impact to a concrete railroad tie to be diagnosed, herein the tie 2, so as, as illustrated schematically in FIG. 3, to generate a vibration V in the tie 2, more precisely in the concrete structure of the latter, herein the concrete body 2.1. Once generated by the mechanical impact stress, the vibration V propagates in the tie 2, more particularly through the concrete structure of the latter, herein the concrete body 2.1, while being reflected by the external surfaces of the tie 2, as well as by internal defects or, more generally, internal structural heterogeneities, such as cracks, such as the crack illustrated in FIG. 3 under the reference F, but also such as voids, segregation interfaces, etc.

In practice, the impact which mechanically stresses the tie 2 to generate the vibration V therein during the application step 101 is of sufficiently low intensity so as not to damage the tie 2 or even displace the latter relative to the support on which the tie rests, typically the ballast when the application step 101 is carried out on a railroad track. In addition, the intensity of the impact is dimensioned so that the resulting vibration V in the concrete structure of the tie 2 has a wavelength appropriate to the structural damage that the structural diagnosis method aims to characterize. To this end, the impact has an energy advantageously less than 3 joules, preferably less than 1 joule.

For the purpose of implementing the application step 101, the structural diagnosis system 1 includes an impactor 10 which is visible schematically in FIGS. 1 and 3. The impactor 10 is suitable for applying by impact the aforementioned mechanical stress to a tie to be diagnosed, herein to the tie 2. As a non-limiting example, the impactor 10 includes an electromagnet which controls the displacement of an impact flyweight. Of course, other embodiments are conceivable for the impactor 10 as long as same serves to mechanically stress by impact, the tie 2 in order to generate the vibration V within the latter.

During the detection step 102, the vibration V is detected at the surface of the diagnosed tie, herein the tie 2, and is transformed into a time-dependent vibratory signal, as illustrated schematically in FIG. 3 wherein the time-dependent vibratory signal is referenced by SV. The time-dependent vibratory signal SV is thereby representative of the change over time, of surface movements of the concrete body 2.1 induced by the vibration V.

For the purpose of implementing the detection step 102, the structural diagnosis system 1 includes a sensor 20 shown schematically in FIGS. 1 and 3. The sensor 20 is suitable for detecting the vibration V and for transforming the latter into the time-dependent vibratory signal SV. As an example, but not limited to, the sensor 20 includes a piezoelectric transducer contact microphone. Of course, other embodiments are conceivable for the sensor 20 as long as the latter transmits a time-dependent vibratory signal, such as the signal SV, obtained by detection and transformation of the vibration V by the sensor.

In the embodiment envisaged in the figures, the impactor 10 and the sensor 20 are advantageously integrated into a portable tool 30 of the structural diagnosis system 1. The portable tool 30 can be controlled by hand by the operator using the structural diagnosis system 1, in particular in situ. The portable tool 30 includes e.g. a housing 31, wherein the impactor 10 and the sensor 20 are arranged and which is apt to be applied against the tie 2 so as to bring the impactor 10 and the sensor 20 into contact with the latter, as illustrated schematically in FIG. 3. The portable tool 30 herein also includes a handle 32, which extends from the housing 31 and which enables the operator to control and manipulate the portable tool 30 in a practical manner. More particularly, the handle 32 is provided with a manual release 33 the actuation of which by the operator controls the impactor 10. In practice, the shape and the dimensions of the handle 32 are not limiting.

During the processing step 103, the time-dependent vibratory signal SV is processed electronically so as to obtain a frequency spectrum therefrom, illustrated schematically in FIG. 3 under the reference SF. The frequency spectrum SF is thereby representative of a spectral amplitude as a function of the frequency, typically quantified in hertz, of symbol Hz. According to an efficient and high-performance embodiment, during the processing step 103, the time-dependent vibratory signal SV is, at least in part, mathematically transformed over a frequency domain in order to have the frequency spectrum SF available: the corresponding mathematical transformation is e.g. a Fourier transform, in particular a Fast Fourier Transform. Moreover, what is subjected to the aforementioned mathematical transformation is advantageously only a part of the time-dependent vibratory signal SV, namely a filtered part, which is obtained by applying a bandpass filter to the time-dependent vibratory signal, more particularly to only a significant part of the signal, extracted from the time-dependent vibratory signal by using e.g. a threshold value applied to the amplitude of the signal. According to a preferential dimensioning which results in remarkable performances for the structural diagnosis method, the aforementioned bandpass filter has a low cut-off frequency equal to 3,000 Hz, preferably 3,500 Hz, and a high cut-off frequency equal to 20,000 Hz, preferably 15,500 Hz.

In practice, it should be noted that the absolute values of the amplitude of the frequency spectrum SF, obtained at the end of the processing step 103, are not of interest for the structural diagnosis method, in the sense that the absolute values are not intended to be exploited in the method. On the other hand, the variation of the amplitude of the frequency spectrum SF as a function of the frequency is of interest, in particular to identify thereto one or a plurality of peaks, as discussed again thereafter.

For the purpose of the implementation of the processing step 103, the structural diagnosis system 1 includes an electronic processing unit 40 which is shown schematically in FIGS. 1 and 3. The electronic processing unit 40 is suitable for processing the time-dependent vibratory signal SV so as to obtain the frequency spectrum SF therefrom. The electronic processing unit 40 is advantageously suitable for successively extracting a significant part of the time-dependent vibratory signal SV and applying the aforementioned bandpass filter, then the aforementioned mathematical transformation. In any case, the embodiment of the electronic processing unit 40 is not limiting. In practice, the electronic processing unit 40 can either comprise an assembly of analog electronic components dedicated to the processing operations implemented by the electronic processing unit 40, or comprise a digital electronics assembly, typically including a microprocessor or similar, programmed to implement the aforementioned processing operations.

In the embodiment envisaged in the figures, the electronic processing unit 40 is advantageously integrated into a portable computer equipment 50, such as a tablet or a laptop computer or else a specific terminal. The interest of the portable computer equipment 50 will appear a little further.

During the analysis step 104, the frequency spectrum SF is compared with a reference to deduce therefrom a structural damage characterization of the diagnosed tie, herein the tie 2. Various embodiments are conceivable for the analysis step 104, in particular according to the nature of the aforementioned reference, as well as according to the way the frequency spectrum SF is compared with the reference. Before explaining in more detail such aspect of the structural diagnosis method, it will be noted that, for the purpose of the implementation of the analysis step 104, the structural diagnosis system 1 includes means of analysis 60 illustrated schematically in FIG. 1. The means of analysis 60 are suitable for determining the structural damage characterization of the diagnosed tie, by comparing the frequency spectrum SF supplied to the means of analysis 60 by the processing unit 40 with the aforementioned reference. Various embodiments of the means of analysis 60 will be described in greater detail thereafter, being associated with the different embodiments of the analysis step 104, explained later. Given the above, in all cases, at least part of the means of analysis 60 is advantageously computerized, being apt to process the frequency spectrum SF supplied by the electronic processing unit 40. More particularly, the computerized part of the means of analysis 60 includes:
a computerized processing unit 61, which is integrated into the portable computerized equipment 50 and which, where appropriate, shares all or part of the digital electronics package of the electronic processing unit 40, and/or
a remote computerized equipment item 62, such as a computer or a server, which is apt to read a transportable data carrier from the portable computerized equipment 50 or which is in wireless communication with the portable computerized equipment 50.

In the embodiment envisaged in FIG. 1, the impactor 10, the sensor 20 and the electronic processing unit 40, as well as the computerized processing unit 61 of the means of analysis 60 form a portable equipment assembly, which can be used by an operator on a railroad track and which, herein, combines the portable tool 30 and the portable computerized equipment 50.

A first embodiment of the analysis step 104 is illustrated by each of the inserts a) and b) in the FIG. 4. In the first embodiment, the reference used in the analysis step 104 consists of a predetermined reference spectrum SR, which is shown in dotted lines on the inserts a) and b) of FIG. 4 and which is e.g. stored in an ad hoc memory of the means of analysis 60. In practice, the reference spectrum SR is e.g. acquired either by a prior implementation of the application 101, detection 102 and processing 103 steps on a reference tie, typically a tie the structural damage of which is known to correspond to normal wear, or by a prior statistical processing of results obtained by implementation of the application 101, detection 102 and processing 103 steps on a considered homogeneous population of ties.

Moreover, in the first embodiment of the analysis step 104, the reference spectrum SR and the frequency spectrum SF, as derived from the application 101, detection 102 and processing 103 steps applied to a tie to be diagnosed, such as the tie 2, are displayed, typically on a screen of the means of analysis 60, herein a screen 51 integrated into the portable computer equipment 50, so that, by direct visual observation, the operator evaluates the comparison between the reference spectrum SR and the frequency spectrum SF and deduces therefrom the structural damage characteristic for the diagnosed tie. Thereby, such deduction is made by the operator in situ, i.e. directly on the railroad track. In practice, the respective displays of the reference spectrum SR and of the frequency spectrum SF on the screen 51 are advantageously simultaneous and superimposed: as corresponding schematic illustrations, the frequency spectrum associated with a first tie to be diagnosed is represented in solid lines on the insert a) of FIG. 4, being labeled E1 therein, and the frequency spectrum associated with a second tie to be diagnosed is represented in solid lines on the insert b) of FIG. 4, being labeled E2 therein, whereas on the two inserts, the reference SR is shown in dotted lines.

In practice, the structural damage characterization is e.g. for the operator to determine that the structural damage of the diagnosed tie is either normal, i.e. similar to same of the reference tie, as in the case illustrated in insert a) of FIG. 4, or abnormal, i.e. substantially different from same of the reference tie, as in the case illustrated in insert b) of FIG. 4. On a railroad track, the operator can thereby quickly determine, among all the ties of a railroad track, the ties the structural damage of which is abnormal.

A second embodiment of the analysis step 104 is illustrated by the inserts a), b), and c) in FIG. 4.

There again, the reference used in the analysis step 104 consists of a reference spectrum, herein the reference spectrum SR described hereinabove for the first embodiment.

Moreover, in the second embodiment, the frequency spectrum SF, as derived from the application 101, detection 102 and processing 103 steps, is compared by computer means with the reference spectrum SR, by computing a distance score which is representative of a mathematical distance between the reference spectrum SR and the frequency spectrum SF. The specificities of the computation of the distance score are not limiting, being emphasized that various computation formulas are known in the art, such as the so-called DTW formulas which is the acronym of the English expression in Dynamic Time Warping, the so-called DTW formulas relying on the difference between respective peaks of the reference spectrum and of the frequency spectrum analyzed, as illustrated schematically by the double-pointed arrows, drawn schematically on the insert b) in FIG. 4.

In any case, for each diagnosed tie, an associated distance score is computed and the structural damage characteristic is determined from the computed distance score. As a schematic illustration, distance scores computed for the frequency spectrum labeled E1 on insert a) of FIG. 4 and for the frequency spectrum labeled E2 on insert b), respectively, in FIG. 4 are, on insert c) in FIG. 4, plotted on a distance score axis D the zero origin of which corresponds to the distance score, necessarily zero, for the reference spectrum SR. It should be understood that it is thereby possible to evaluate to what extent the structural damage of a diagnosed tie is more distant or less distant from the structural damage of the reference tie and thus, e.g., to classify the ties diagnosed along a railroad track into two or more categories.

In practice, the computation of the distance score of each diagnosed tie is advantageously carried out by an ad hoc computer program of the computerized part of the means of analysis 60. Thereof amounts to saying that the means of analysis 60 are configured to compare, by computer means, the frequency spectrum of the diagnosed tie with a reference spectrum, by computing a corresponding distance score, and to determine the structural damage characterization for the diagnosed tie from the computed distance score, being noted that the determination can also be carried out computer means and/or by a human operator.

A third embodiment of the analysis step 104 is illustrated by the inserts a) and b) in FIG. 5.

In the third embodiment, the reference used in the analysis step 104 consists of a plurality of reference spectra, which are individually similar to the reference spectrum SR described hereinabove in the first and second embodiments, but which differ from one another by corresponding to frequency spectra representative of predetermined structural damage states, respectively, which are different from one another. As a schematic illustration, in insert a) in FIG. 5, four structural damage states, different from each other, respectively, are considered, being associated with reference spectra labeled SR1, SR2, SR3 and SR4, respectively. Of course, the number of reference spectra, herein equal to four, is only a non-limiting example. The four reference spectra are illustrated herein in a representation space which is herein two-dimensional, being defined by two orthonormal axes, namely a first distance score axis D1 and a second distance score axis D2, the respective distance score computations of which are different from each other. Thereby, it is understood that, herein, the representation space is reduced along two main axes of variation. More generally, and as mentioned again further down, it should be understood, through the present example, that it is possible to envisage resorting to other dimensional reduction techniques than same illustrated in FIG. 5, where appropriate, by providing a number of dimensions other than two as in the example illustrated in FIG. 5.

In addition, in the third embodiment of the analysis step 104, the distance scores associated with the diagnosed tie are computed for each diagnosed tie along the distance score axes D1 and D2, respectively, which makes it possible to evaluate the “position” of the diagnosed tie in the aforementioned representation space, as illustrated schematically in insert b) in FIG. 5. From such “position”, a structural damage characterization for the diagnosed tie can be determined, e.g. by classifying the diagnosed ties along a railroad track into various categories according to the respective “positions” of the ties in the representation space.

Herein again, in practice, the computation of the distance score of each diagnosed tie is advantageously carried out by an ad hoc computer program of the computerized part of the means of analysis 60. Thereof amounts to saying that the means of analysis 60 are configured to compare, by computer means, the frequency spectrum of each diagnosed tie with a plurality of reference spectra, by computing a corresponding distance score, and to determine, in particular by computer means, the structural damage characterization for the diagnosed tie from the computed distance score.

Other embodiments of the analysis step 104. As non-exhaustive examples:
breakdown into groups of the measurements made in order to define groups of resemblance with respect to the distance between the frequency spectra, using machine learning techniques such as K-means clustering; and/or
representation of the position of measurements along reduced axes using non-linear dimension reduction techniques, in order to evaluate the positionings of the measurements relative to each other in a reduced and more easily interpretable representation, such as a one-dimensional, two-dimensional or three-dimensional representation.

Whichever the embodiment of the analysis step 104, it is understood that the structural diagnosis method results in determining a structural damage characterization for each of the diagnosed ties. The structural damage characterization associates with the diagnosed tie, a structural state among a plurality of states which are predetermined and/or classified a posteriori. Thereby, the structural damage characterization provides information, with a controlled margin of error, in particular on:
the presence of at least one structural defect belonging to one or a plurality of given types of defect, such as the crack F mentioned hereinabove, and/or
more marked structural wear than the nominal structural wear.

Also, whichever the embodiment of the analysis step 104, the implementation of the analysis step 104 potentially involves the operator for the deduction of the structural damage characterization, in which case the means of analysis 60 provide the operator, by computer processing, with the necessary evaluation information, e.g. in the form of at least one comparative display, as in the first embodiment discussed in detail hereinabove. Alternatively, the implementation of the analysis step 104 is entirely computerized, which may require significant computing powers, in particular made available by the remote computerized equipment 52.

Finally, various arrangements and variants of the structural diagnosis method, as well as of the structural diagnosis system 1, described hitherto, are conceivable. Examples include:
the vibration V is detectable and measurable by a plurality of sensors of the structural diagnosis system, such as the sensor 20, the different sensors being apt to be distributed over the tie to be diagnosed;
The vibration V can be generated by a plurality of impactors of the structural diagnosis system, such as the impactor 10, then being, where appropriate, detected by a single sensor, such as the sensor 20, the different impactors being apt to be distributed over the tie to be diagnosed; and/or 10
rather than the entire analysis step 104 is implemented in situ, i.e. on the railroad, part of the analysis step 104 can be implemented remotely from the railroad, e.g. in an office.

1. A method of structural diagnosis of concrete railroad ties, comprising:
an application step, wherein a mechanical stress is applied by impact to a concrete railroad tie to be diagnosed,
a detection step, wherein a vibration generated by the mechanical stress and propagating through the diagnosed tie is detected on the surface of the diagnosed tie and is transformed into a time-dependent vibratory signal,
a processing step, wherein the time-dependent vibratory signal is processed electronically so as to obtain a frequency spectrum, and
an analysis step, wherein the frequency spectrum is compared with a reference in order to derive therefrom a structural damage characterization of the diagnosed tie,
wherein, in the analysis step:
the frequency spectrum is compared by computer means with a reference spectrum forming said reference, by computing a distance score which is representative of a mathematical distance between the frequency spectrum and the reference spectrum, and
the structural damage characterization is determined from the computed distance score.

2. The method according to claim 1, wherein the application step, the detection step, the processing step, and at least a part of the analysis step are carried out on railroad tracks.

3. The method according to claim 1, wherein, during the analysis step:
the frequency spectrum is compared by computer means with a plurality of reference spectra forming said reference, by computing distance scores which are representative of mathematical distances between the frequency spectrum and the reference spectra, respectively, and
the structural damage characterization is determined from the computed distance scores.

4. The method according to claim 1, wherein in the application step, the mechanical stress is applied to the tie to be diagnosed by an impact having an energy of less than 3 joules, preferably less than 1 joule.

5. The method according to claim 1, wherein, in the processing step, the time-dependent vibratory signal is processed so as to extract a significant part therefrom, before applying to the significant part, a bandpass filter and then a mathematical transformation on a frequency domain to get the frequency spectrum.

6. The method according to claim 5, wherein the bandpass filter has a low cut-off frequency substantially equal to 3,000 Hz, preferably 3,500 Hz, and a high cut-off frequency substantially equal to 20,000 HZ, preferably 15,500 Hz.

7. A structural diagnosis system for concrete railroad ties, including:
at least one impactor suitable for applying a mechanical stress to a concrete railroad tie to be diagnosed,
at least one sensor suitable for both detecting, on the surface of the diagnosed tie, a vibration generated by the mechanical stress and propagating in the diagnosed tie, and for transforming the vibration into a time-dependent vibratory signal,
an electronic processing unit, suitable for processing the time-dependent vibratory signal so as to obtain a frequency spectrum therefrom, and
means of analysis, suitable for comparing the frequency spectrum with a reference in order to deduce therefrom a structural damage characterization of the diagnosed tie,
wherein the means of analysis are configured to implement an analysis step wherein
the frequency spectrum is compared by computer means with a reference spectrum forming a reference, by computing a distance score that is representative of a mathematical distance between the frequency spectrum and the reference spectrum, and
the structural damage characterization is determined from the computed distance score.

8. The system according to claim 7, wherein the impactor(s), the sensor(s) and the electronic processing unit, and at least a part of the means of analysis form a portable equipment assembly usable by a human operator on a railroad track.
